(19) United States
(12) Patent Application Publication
(10) Pub. No.: US 2009/0064765 A1
(43) Pub. Date: Mar. 12, 2009

(54) Method of Manufacturing Semiconductor Device

(75) Inventor: Yasuhiro Megawa, Toyama-shi (JP)

Correspondence Address: OLIFF & BERRIDGE, PLC, P.O. BOX 320850, ALEXANDRIA, VA, 22320-4850, US

(73) Assignee: HITACHI KOKUSAI ELECTRIC INC., TOKYO (JP)

(21) Appl. No.: 12/224,880

(22) PCT Filed: Mar. 28, 2007
(86) PCT No.: PCT/JP2007/056699

§ 371 Date: Oct. 2, 2008

(30) Foreign Application Priority Data
Mar. 28, 2006 (JP) 2006-087461

(51) Int. Cl. G01M 3/04

(52) U.S. Cl. 73/40.7

(57) ABSTRACT

A method of manufacturing a semiconductor device including the step of: carrying a substrate into a reaction tube; processing the substrate by supplying a gas into the reaction tube from a gas supply line, while exhausting an inside of the reaction tube through the exhaust line by means of an exhaust device and controlling pressure in the reaction tube on the basis of an output from a pressure sensor provided in the exhaust line; carrying the processed substrate out from the reaction tube; and carrying out a leakage check for a gas flowing path including the gas supply line, the reaction tube and the exhaust line, wherein, in the step of carrying out the leakage check, the gas flowing path is divided into plural sections connecting with at least the pressure sensor and the exhaust device, the respective sections are exhausted by means of the exhaust device with an upstream end of each section being closed and pressure in each section is measured by means of the pressure sensor to judge for every section whether leakage is found in the gas flowing path or not on the basis of the measured pressure.

### TECHNICAL FIELD

The present invention relates to a method of manufacturing a semiconductor device in the case of treating a substrate such as a silicon wafer and a glass board to manufacture a semiconductor device.

### BACKGROUND ART

In a process of treating a substrate to manufacture a semiconductor device, carried out are various kinds of substrate treatment such as forming of a thin film, diffusion of impurities, an annealing process and etching. In a substrate treatment process, control of treatment pressure has an influence on quality of substrate treatment such as substrate quality. Accordingly, pressure in a treatment chamber in which a substrate is treated is controlled to be a predetermined treatment pressure on the basis of a result of detection made by a pressure sensor.

Further, leakage from the treatment chamber and a gas supplying and exhausting line affects control of the treatment pressure, and thereby, quality of treatment of a substrate. Accordingly, it is indispensable to inspect existence of leakage in the treatment chamber and the gas supplying and exhausting line.

Patent Reference 1: JP-A-H09-280995

### DISCLOSURE OF THE INVENTION

### Problems that the Invention is to Solve

In view of the above, the invention is to provide a method of manufacturing a semiconductor device, the method enabling leakage from a gas supplying and exhausting line to be detected to improve quality of treatment of a substrate and a yield.

### Means for Solving the Problems

The invention relates to a method of manufacturing a semiconductor device comprising: a process of carrying a substrate into a reaction tube; a process of treating the substrate by supplying the reaction tube with a gas from a gas supplying line, carrying out exhaust through an exhausting line by means of an exhaust device and controlling pressure in the reaction tube on the basis of an output from a pressure sensor provided in the exhausting line; a process of carrying the treated substrate out from the reaction tube; and a process of carrying out a leakage check for a gas flowing path including the gas supplying line, the reaction tube and the exhausting line, wherein, in the process of carrying out a leakage check, the gas flowing path is divided into plural sections connecting with at least the pressure sensor and the exhaust device, the respective sections are exhausted by means of the exhaust device with an upstream end of each section being closed and the pressure in each section is measured by means of the pressure sensor to judge for every section whether leakage is found in the gas flowing path or not on the basis of the measured pressure.

Further, the invention relates to a method of manufacturing a semiconductor device comprising: a process of carrying a substrate into a reaction tube; a process of treating a substrate by supplying the reaction tube with a gas from a gas supplying line, carrying out exhaust through the exhausting line by means of an exhaust device and controlling pressure in the reaction tube on the basis of an output from a pressure sensor provided in the exhausting line; a process of carrying out the treated substrate out from the reaction tube; and a process of carrying out a leakage check for at least the exhausting line in a gas flowing path including the gas supplying line, the reaction tube and the exhausting line, wherein, in the process of carrying out a leakage check, the exhausting line is divided into plural sections connecting with at least the pressure sensor and the exhaust device, the respective sections are exhausted by means of the exhaust device with an upstream end of each section being closed and the pressure in each section is measured by means of the pressure sensor to judge for every section whether leakage is found in the exhausting line or not on the basis of the measured pressure.

### EFFECT OF THE INVENTION

In accordance with the invention, the gas flowing path can be checked for leakage for each of plural sections, so that a leakage point can be quickly and easily specified in the case that the leakage exists. Moreover, using the pressure sensor provided in the exhausting line allows the exhausting line to be individually checked for leakage. This allows an excellent effect of improving quality control of treatment of a substrate and a yield to be achieved.

Further, in accordance with the invention, at least the exhausting line in the gas flowing path can be checked for leakage for each of plural sections, so that a leakage point can be quickly and easily specified even in the case that leakage exists in the exhausting line. This allows an excellent effect of improving quality control of treatment of a substrate and a yield to be achieved.

### BRIEF DESCRIPTION OF THE DRAWINGS

FIG. 1 is a schematic view of a structure of an embodiment of the invention.

FIG. 2 is a sectional view of an example of a treating furnace used in an embodiment of the invention.

FIG. 3 is a schematic view of a structure of a water vapor generating device used in an embodiment of the invention.

FIG. 4 illustrates a leakage check in an embodiment of the invention.

FIG. 5 illustrates a leakage check in an embodiment of the invention.

FIG. 6 illustrates a leakage check in an embodiment of the invention.

### DESCRIPTION OF REFERENCE SIGNS AND NUMERALS

1: SOAKING TUBE
2: REACTION TUBE
3: GAS SUPPLYING TUBE
4: GAS EXHAUSTING TUBE
5: INTRODUCTION PORT
9: EXHAUST PORT
16: BOAT
18: BOAT ELEVATOR
19: TREATING CHAMBER
20: TREATING FURNACE
23: RELATIVE PRESSURE DETECTING SENSOR
24: PRESSURE CONTROL VALVE
24b: ABSOLUTE PRESSURE DETECTING SENSOR
30: EXHAUSTING LINE
31: GAS COOLER

### BEST MODE FOR CARRYING OUT THE INVENTION

Best mode for carrying out the invention will be described hereinafter, made reference to the drawings.

Examples of a substrate processing device used for manufacturing a semiconductor device include a single wafer processing device that treats a substrate one by one and a batch type substrate processing device that treats a predetermined number of substrates at a time. In the following description, described will be an example that the invention is put into practice with the batch type substrate processing device.

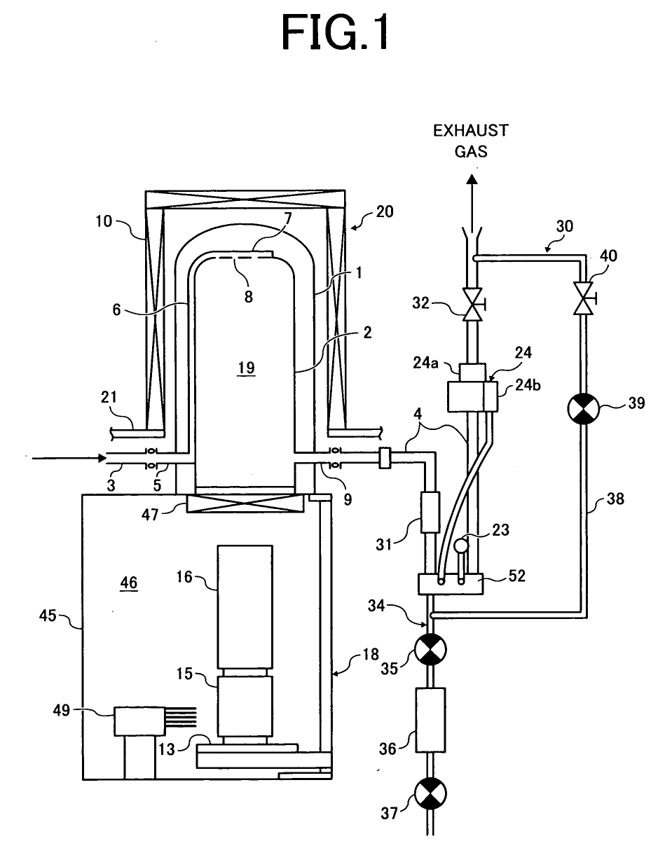

First, schematically described will be a batch type substrate processing device in FIG. 1.

A reaction tube 2 is concentrically provided inside a soaking tube 1. A heater 10 is concentrically provided so as to enclose a circumference of the reaction tube 2. The heater 10 is erectly provided on a heater base 21. The reaction tube 2 is erectly provided on an airtight container 45. The airtight container 45 defines a loading chamber 46. The loading chamber 46 is communicated with a treating chamber 19 through a furnace opening part. The furnace opening part is arranged to be capable of being closed air-tightly by means of a furnace opening shutter 47. The soaking tube 1, the reaction tube 2, the heater 10 and the like form a treating furnace 20.

On an upper surface of the reaction tube 2, provided is a gas collecting part 7 with which a gas supplying tube 3 is communicated through an introduction port 5 and a conduit 6 so that the treated gas would be introduced thereto in a state of a shower through a dispersion hole 8. Further, an exhaust port 9 communicates with a lower part of the reaction tube 2. The exhaust port 9 is connected to a gas exhausting tube 4 for exhausting an atmosphere in the treating chamber 19. A downstream side of the gas exhausting tube 4 forms an exhausting line 30, as described later.

In the loading chamber 46, housed are a boat elevator 18 and a substrate loading machine 49. The boat elevator 18 holds a substrate holding tool (a boat) 16 through a sealing cap 13 so as to be capable of ascent and descent. The boat elevator 18 raises and lowers the boat 16 so that the boat 16 can be loaded in and drawn from the treating chamber 19. The sealing cap 13 is capable of air-tightly closing the furnace opening part under the raised condition.

The substrate loading machine 49 is provided so as to face to the boat elevator 18. The substrate loading machine 49 can load the boat 16, which is in a state of descent, with an untreated substrate and can remove a treated substrate from the boat 16.

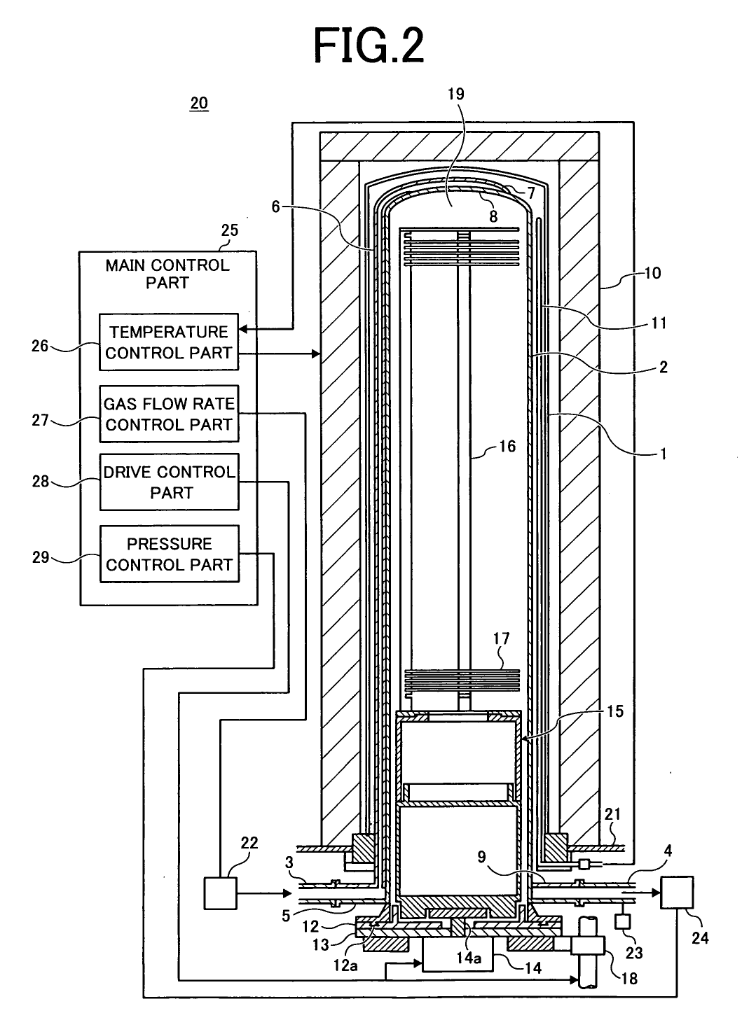

An example of the treating furnace 20 will be described, made reference to FIG. 2.

The soaking tube 1 is formed from a heat-resistant material such as silicon carbide (SiC), for example. The shape of the soaking tube 1 is closed in its upper end and open in its lower end. The reaction tube 2 is formed from a heat-resistant material such as quartz (SiO₂), for example. The shape of the reaction tube 2 is a cylinder whose upper end is closed and whose lower end is open. The conduit 6 and the exhaust port 9 are also formed from a heat-resistant material such as quartz (SiO₂), for example, similarly to the reaction tube 2. The boat 16 is housed in the treating chamber 19 and formed from a heat-resistant material such as quartz and silicon carbide, for example. The boat 16 is arranged to hold a substrate (wafer) 17 horizontally in multiple layers. The boat 16 is provided in its lower part with a boat cap 15 having a thermal insulating function.

The boat cap 15 is formed from a heat-resistant material such as quartz and silicon carbide, for example. The boat cap 15 is arranged to be formed so that conduction of the heat from the heater 10 to a lower end side of the reaction tube 2 would be difficult.

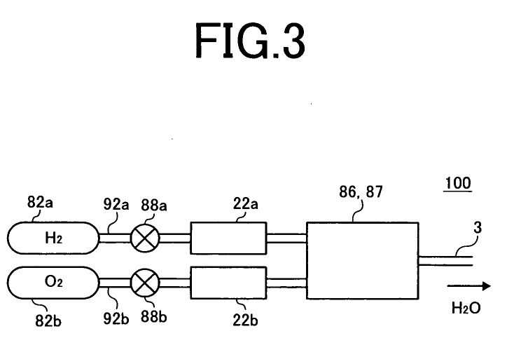

The gas supplying tube 3 is connected to a treating gas supplying source, a carrier gas supplying source and an inert gas supplying source, which are not shown, through an MFC (mass flow controller) 22 used as a gas flow rate controller. A later-mentioned water vapor generating device 100 (in FIG. 3) is provided on a downstream side of the mass flow controller 22 in the case of necessity of supplying the treating chamber 19 with water vapor. The mass flow controller 22 is electrically connected to the gas flow rate control part 27 so as to be arranged to be controlled in desired timing for the purpose of achieving the desired flow rate of the supplied gas. The gas supplying tube 3, the mass flow controller 22 and such form a gas supplying line.

On a downstream side of the gas exhausting tube 4, provided are a relative pressure detecting sensor 23, which is used as a pressure detector, and a pressure control valve 24. The pressure control valve 24 includes a vacuum generator 24a (which is later mentioned) and is arranged to be capable of exhausting a gas so that the pressure in the treating chamber 19 would be a predetermined pressure. A pressure control part 29 is electrically connected to the pressure control valve 24, the relative pressure detecting sensor 23, a later-mentioned absolute pressure detecting sensor 24b, a later-mentioned air valve 39 and the like. The pressure control part 29 is arranged to control an opening and closing operation of the later-mentioned air valve 39 in desired timing on the basis of the pressure detected by the relative pressure detecting sensor 23 and to carry out control in desired timing on the basis of the pressure detected by the absolute pressure detecting sensor 24b so that the pressure in the treating chamber 19 would be a desired pressure by means of the pressure control valve 24. The gas exhausting tube 4, the pressure control valve 24 and such form an exhausting line 30.

In a lower end part of the reaction tube 2, provided are a base 12 and the sealing cap 13 used as a lid body of the furnace opening. The sealing cap 13 is made of metal such as stainless, for example, and formed into the shape of a disk. The base 12 is made of quartz, for example, and formed into the shape of a disk to be mounted on the sealing cap 13. On an upper surface of the base 12, provided is an O-ring 12a as a sealing member in contact with the lower end of the reaction tube 2.

A rotating means 14 for rotating the boat is provided on the lower side of the sealing cap 13. An axis of rotation 14a of the rotating means 14 passes through the sealing cap 13 and the base 12. The axis of rotation 14a is arranged to hold the boat 16 through the boat cap 15 and to rotate the boat 16 through the boat cap 15.

The sealing cap 13 is held on the boat elevator 18, as described above. Ascent and descent of the boat 16 by means of the boat elevator 18 allow the boat to be carried into and out from the treating chamber 19. The rotating means 14 and the boat elevator 18 are electrically connected to a drive control part 28 so that control for a desired operation would be carried out in desired timing.

A temperature sensor 11 used as a temperature detector is provided between the soaking tube 1 and the reaction tube 2. The heater 10 and the temperature sensor 11 are electrically connected to a temperature control part 26. The temperature control part 26 is arranged to carry out control in desired timing so that the temperature of the treating chamber 19 would have desired temperature distribution by adjusting a state of electricity flowing to the heater 10 on the basis of temperature information detected by means of the temperature sensor 11.

The temperature control part 26, the gas flow rate control part 27, the pressure control part 29 and the drive control part 28 also form an operation part and an input and output part. The temperature control part 26, the gas flow rate control part 27, the pressure control part 29 and the drive control part 28 are arranged to form a main control part 25.

An example of the water vapor generating device 100 will be described, made reference to FIG. 3.

As an example of the water vapor generating device 100, described will be a device for generating water vapor (H₂O) by means of an external combustion device (an external torch). The water vapor generating device 100 includes a hydrogen (H₂) gas source 82a, an oxygen (O₂) gas source 82b and an external combustion device 86. The hydrogen (H₂) gas source 82a and the oxygen (O₂) gas source 82b are connected in parallel to the external combustion device 86 through opening and closing valves 88a and 88b and MFCs (mass flow controllers) 22a and 22b by means of gas supplying tubes 92a and 92b, respectively.

The external combustion device 86 is connected to the gas supplying tube 3 for supplying the treating chamber 19 with generated moisture. The MFCs 22a and 22b, the opening and closing valves 88a and 88b and the external combustion device 86 are electrically connected to the gas flow rate control part 27 (in FIG. 2). This causes control to be carried out in desired timing so that the flow rate of the H₂ gas and the O₂ gas, which are supplied from the hydrogen (H₂) gas source 82a and the oxygen (O₂) gas source 82b, and the flow rate of the water vapor (H₂O) which is generated in and supplied from the external combustion device 86, would be desired quantity.

In the water vapor generating device 100, the H₂ gas and the O₂ gas, which are supplied from the hydrogen (H₂) gas source 82a and the oxygen (O₂) gas source 82b, are burned in the external combustion device 86 to generate water vapor (H₂O). The generated water vapor (H₂O) is supplied to the treating chamber 19 from the external combustion device 86 through the gas supplying tube 3.

As an example of the water vapor generating device 100, used may be a water vapor generating device using catalysis instead of using the external combustion device (the external torch) generating water vapor (H₂O). In the case of using catalysis, a catalytic device 87 is used in place of the external combustion device 86 shown in FIG. 3. The structure other than the above is similar to that of the water vapor generating device using the external combustion device (the external torch).

In the water vapor generating device 100 using the catalytic device 87, the H₂ gas and the O₂ gas, which are supplied from the hydrogen gas source 82a and the oxygen gas source 82b, contact with a catalyst such as platinum, which is provided in the catalytic device 87. The H₂ gas and the O₂ gas, which contacted with platinum and the like, are activated in accordance with catalysis of the platinum and the like to be promoted in reaction. The activated H₂ gas and O₂ gas react at a temperature lower than the ignition temperature to generate water vapor (H₂O). The generated water vapor (H₂O) is supplied to the treating chamber 19 from the catalytic device 87 through the gas supplying tube 3. In accordance with the water vapor generating device 100 using the catalytic device 87, water vapor can be generated without high temperature combustion like the water vapor generating device 100 using the external combustion device 86.

The exhausting line 30 will be described with reference to FIG. 1.

The gas exhausting tube 4 connected to the exhaust port 9 is made of heat-resistant and corrosion-resistant synthetic resin, fluorocarbon resin such as Teflon (a registered trademark), for example, and is connected to a duct and the like of a plant exhaust device. In the gas exhausting tube 4, provided to the downstream side are a gas cooler 31, the absolute pressure detecting sensor 24b, the relative pressure detecting sensor 23, the pressure control valve 24, the vacuum generator 24a, a first opening and closing valve 32 and such. The relative pressure detecting sensor 23 is a differential pressure type sensor (a relative pressure gauge) and can detect a differential pressure between the treating chamber 19 and the outside air. A fluid discharging line 34 communicates with a downstream side of the gas cooler 31. The fluid discharging line 34 is provided with a first air valve 35, a drain tank 36, which is a reservoir, and a second air valve 37 in order toward the downstream side.

The drain tank 36 has the capacity capable of reserving sufficient moisture generated in one treatment.

The gas exhausting tube 4, the fluid discharging line 34, the relative pressure detecting sensor 23 and the absolute detecting sensor 24b are connected to a close 52 and communicate with each other through the close 52. The close 52 is made of fluorocarbon resin, for example, and has a gas flowing path formed therein. The relative pressure detecting sensor 23 and the absolute pressure detecting sensor 24b respectively detect the relative pressure and the absolute pressure of the exhaust pressure in exhausting the treating chamber 19, concretely, the exhaust pressure in the close 52.

The gas cooler 31 and the first air valve 35 in the fluid discharging line 34, that is, an upstream side of the first air valve 35 in the fluid discharging line 34 and a downstream side of the first opening and closing valve 32 of the gas exhausting tube 4 are connected by means of a bypass line 38. The bypass line 38 is provided with a third air valve 39 and a second opening and closing valve 40 in order from the fluid discharging line 34 to the gas exhausting tube 4. The third air valve 39 is arranged to be made open when the pressure in the treating chamber 19 is equal to that of the outside air so as to let the pressure in the treating chamber 19 be released. The third air valve 39 is arranged to be made open when the relative pressure detecting sensor 23 detects a pressure equal to or larger than the pressure of the outside air for the purpose of preventing the reaction tube 2 from being broken due to excessive pressurization, so as to let the pressure in the treating chamber 19 to be released.

The pressure control valve 24 includes a vacuum generator 24a such as a vacuum pump, which is used as an exhaust device, and the absolute pressure detecting sensor (an absolute pressure gauge) 24b, which is used as a pressure detector for detecting the absolute pressure in the treating chamber 19. The vacuum generator 24a is connected to an N₂ supplying line (not shown) for generating vacuum pressure. The absolute pressure detecting sensor 24b is arranged to detect the absolute pressure in the gas exhausting tube 4.

Now, described will be a method of carrying out treatment such as oxidation and diffusion, which is preformed as one of processes of manufacturing a semiconductor device, for the wafer 17 with the treating furnace 20 in accordance with the structure. In the following description, the main control part 25 controls an operation of each part forming the substrate processing device.

A leakage check for the exhausting line 30 and the like is carried out as a pre-process for starting the treatment of a substrate. The substantial substrate treatment is started after confirmation that no leakage is found in the exhausting line 30 and the like. The leakage check before the substrate treatment allows a defect in processing a substrate to be prevented from occurring, and thereby, the yield to be improved.

The leakage check for the exhausting line 30 and the like is preferably carried out in setting up the substrate processing device. Further, the leakage check for the exhausting line 30 and the like may be performed before the later-mentioned boat 16 is carried into the treating chamber 19 or may be performed as a process preceding to supply of the treating gas after the later-mentioned boat 16 is carried into the treating chamber 19 (after loading of the boat). Otherwise, the leakage check may be carried out at regular intervals between the substrate treatments. Moreover, it is possible to perform the leakage check at a time when any problem is found in the substrate processing device.

In the loading chamber 46, loaded onto the boat 16 are a predetermined number of wafers 17 (charge of a wafer). The boat 16 is then raised by means of the boat elevator 18 to be carried into the treating chamber 19 (loading of the boat). The sealing cap 13 air-tightly closes the lower end (the furnace opening part) of the reaction tube 2 through the base 12 and the O-ring 12a under the condition.

The pressure control valve 24 is controlled so that the pressure in the treating chamber 19 would be a desired pressure (a negative pressure) while the vacuum generator 24a is used to exhaust the treating chamber 19. At that time, the pressure in the treating chamber 19 is measured by means of the absolute pressure detecting sensor 24b. The pressure control valve 24 is feedback-controlled on the basis of the measured pressure. Further, the treating chamber 19 is heated by means of the heater 10 to be raised in temperature so as to be at a desired temperature. A state of electricity flowing to the heater 10 is feedback-controlled at that time on the basis of the temperature information detected by means of the temperature sensor 11 so that the temperature of the treating chamber 19 would have desired temperature distribution. Following to the above, the rotating means 14 rotates the boat cap 15 and the boat 16 to rotate the wafer 17.

The gas supplied from the treating gas supplying source and the carrier gas supplying source, which are not shown, and controlled by the mass flow controller 22 so that the flow rate would be desirable are then introduced to the treating chamber in a state of a shower through the dispersion hole 8 from the gas supplying tube 3 via the introduction port 5, the conduit 6 and the gas collecting part 7.

In the case that the treatment using the water vapor is carried out for the wafer 17, the gas controlled by the mass flow controller 22 so that the flow rate would be desirable is supplied to the water vapor generating device and the gas including water vapor (H₂O) generated in the water vapor generating device is introduced into the treating chamber 19. That is to say, the H₂ gas and the O₂ gas, which are controlled by the mass flow controllers 22a and 22b to have the desired flow rate, are supplied to the external combustion device 86 or the catalytic device 87 to generate water vapor (H₂O), as in FIG. 3, and the gas including the water vapor (H₂O) is introduced into the treating chamber 19. The introduced gas flows down in the treating chamber 19 and passes through the exhausting port 9 to be exhausted from the exhaust tube 4. The gas contacts with a surface of the wafer 17 in passing through the treating chamber 19. This causes the treatment such as oxidation and diffusion to be carried out for the wafer 17.

After the preset treating time passes, supplied from the inert gas supplying source is an inert gas, so that the gas in the treating chamber 19 is substituted for the inert gas. The control pressure valve 24 is then closed in accordance with an instruction from the main control part 25 with the supply of the inert gas being kept and the pressure in the treating chamber 19 is returned to the normal pressure. At that time, the pressure in the treating chamber 19 is measured by means of the relative pressure detecting sensor 23 to carry out feedback control on the basis of the measured pressure. That is to say, the third air valve 39 is controlled to be open so that the reaction tube 2 would not be broken due to excessive pressure in the case that the pressure equal to or more than that of the outside air is detected by means of the relative pressure detecting sensor 23.

Following to the above, the boat 16 is lowered by means of the boat elevator 18 after the temperature of the treating chamber 19 is decreased and the furnace opening part is opened. The treated wafer 17 is simultaneously carried out from the treating chamber 19 (unloading of the boat) into the loading chamber 46 in a state held on the boat 16. The treated wafer 17 is discharged from the substrate loading machine 49 (discharge of a wafer) after certain cooling time has passed. The furnace opening part is air-tightly closed by means of the furnace opening shutter 47.

As a treatment condition in treating a wafer with the treating furnace in accordance with the embodiment, exemplified only as an example are conditions that the treating temperature is 800 to 1000° C., the treating pressure is 940 to 980 hPa, the type of the gas is H₂/O₂ and the gas supplying flow rate is 1 to 10 slm/1 to 20 slm in oxidation treatment, for example. Maintaining the respective treatment conditions fixedly at certain values within the respective ranges allows the substrate treatment to be performed.

Now, described will be the leakage check. The leakage check in setting up the device, however, is different in way from the leakage check before starting the substrate treatment or the leakage check in finding some problem in the device. Accordingly, described first will be the case that the leakage check is performed before starting the substrate treatment or in finding some problem in the device, hereinafter. The case that the leakage check is performed in setting up the device will be described next to the above.

First, described will be a concrete method of measurement of the standard pressure, the measurement being carried out as a preliminary arrangement for the leakage check. It is confirmed in advance that the whole gas flow path formed from the gas supplying tube 3, the reaction tube 2, the exhausting line 30 and such has no leakage. A setting value of the pressure in the furnace is then set at a value sufficiently lower than the pressure of the atmosphere, 800 hPa, for example. The treating chamber 19 is exhausted into a vacuum by means of the vacuum generator 24a used as an exhaust device with no gas flowing in the furnace, namely, with an upstream side of the gas supplying tube 3 being closed (STEP: 00). The vacuum achieved in the above condition is refereed to as evacuation. The pressure in evacuation (the evacuation pressure), namely, the pressure at the time of completing the evacuation is detected by means of the absolute pressure detecting sensor 24b to record the evacuation pressure as data. The evacuation pressure is the pressure used as the standard for the leakage check and stored in a storing part (not shown) of the main control part 25 or the like.

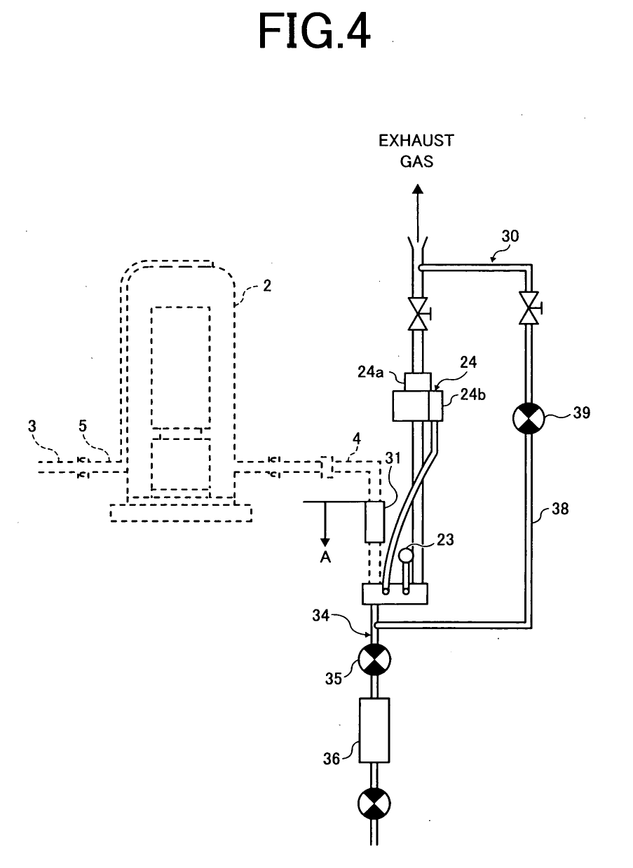

Now, described will be a concrete direction of a leakage check before starting the substrate treatment or in the case of finding some problem in the apparatus. First, set is the setting value of the pressure similarly to the case of STEP: 00. The gas exhausting tube 4 is closed on the upstream side of the gas cooler 31 to vacuum-exhaust the exhausting line 30 by means of the vacuum generator 24a used as an exhaust device, as shown in FIG. 4 (STEP: 01). Providing an air valve on an upstream side of the gas cooler 31 to close the air valve, for example, causes the gas exhausting tube 4 to be closed.

A value of the pressure in the exhausting line 30 at that time is detected by means of the absolute pressure detecting sensor 24b to be compared with the evacuation pressure value obtained in STEP: 00. It is judged that a section reaching the upstream side of the gas cooler 31 (a section A) has no leakage point in the case that the pressure detected in STEP: 01 is same in value as the evacuation pressure. On the other hand, the section A is judged to have a leakage point in the case that the detected pressure value obtained in STEP: 01 is higher than the evacuation pressure value. Closing of the gas exhausting tube 4 is released on the upstream side of the gas cooler 31 after the leakage check of the section A to restore the section A to the atmospheric pressure. The section A may be supplied with an inert gas from the gas supplying tube 3 at that time.

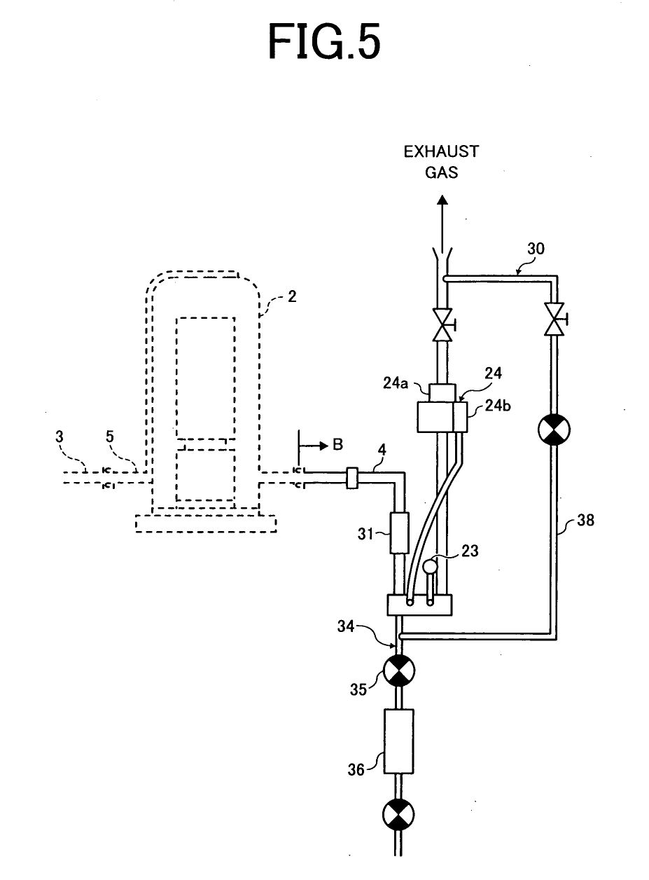

Next, an upstream end (the exhaust port 9, for example) of the gas exhausting tube 4 is closed as shown in FIG. 5 to vacuum-exhaust the exhausting line 30 by means of the vacuum generator 24a used as an exhaust device under a condition that the setting value of the pressure is set similarly to the case of STEP: 00 (STEP: 02). Providing an air valve in the vicinity of an upstream end of the gas exhausting tube 4 to close the air valve, for example, causes the gas exhausting tube 4 to be closed. The pressure in the exhausting line 30 at that time is detected by means of the absolute pressure detecting sensor 24b to be compared with the evacuation pressure value. It is judged that a section reaching the upstream end of the gas exhausting tube 4 (a section B) has no leakage point in the case that the pressure detected in STEP: 02 is same in value as the evacuation pressure. On the other hand, the section B is judged to have a leakage point in the case that the detected pressure value obtained in STEP: 02 is higher than the evacuation pressure value.

In the case that the section A has no leakage point while the section B has a leakage point, for example, it is judged that the leakage point exists in a section where the sections A and B are not overlapped with each other, that is, a section from the upstream side of the gas cooler 31 to the upstream end of the gas exhausting tube 4. Closing of the gas exhausting tube 4 is released on the upstream end of the gas exhausting tube 4 after the leakage check of the section B to restore the section B to the atmospheric pressure. The section B may be supplied with an inert gas from the gas supplying tube 3 at that time.

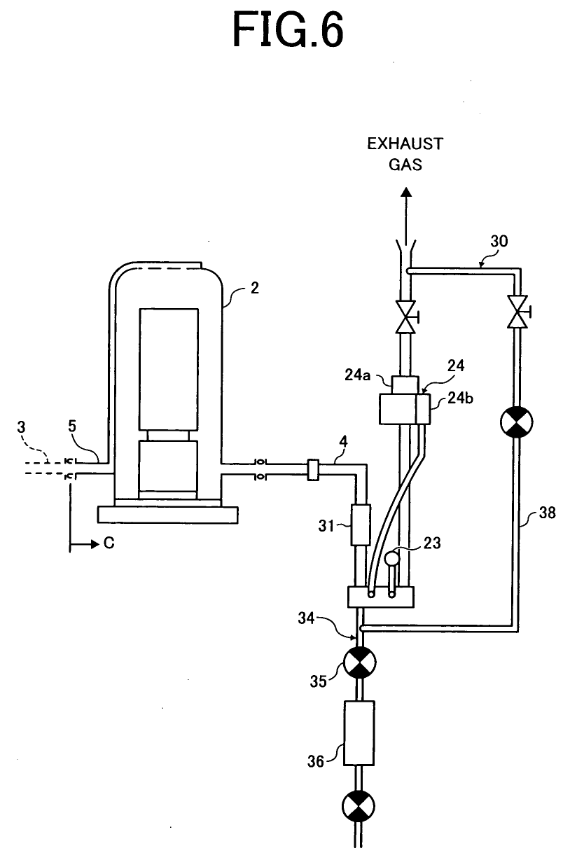

Further, an upstream end of the introduction port 5 is closed as shown in FIG. 6 to vacuum-exhaust the exhausting line 30 and the reaction tube 2 by means of the vacuum generator 24a used as an exhaust device under a condition that the setting value of the pressure is set similarly to the case of STEP: 00 (STEP: 03). Providing an air valve in the vicinity of an upstream end of the introduction port 5 to close the air valve, for example, causes the introduction port 5 to be closed. The pressure in the exhaust line 30 at that time is detected by means of the absolute pressure detecting sensor 24b to be compared with the evacuation pressure value. It is judged that a section reaching the upstream end of the introduction port 5 (a section C) has no leakage point in the case that the pressure detected in STEP: 03 is same in value as the evacuation pressure. On the other hand, the section C is judged to have a leakage point in the case that the detected pressure value obtained in STEP: 03 is higher than the evacuation pressure value.

In the case that the section B has no leakage point while the section C has a leakage point, for example, it is judged that the leakage point exists in a section where the sections B and C are not overlapped with each other, that is, a section from the upstream end of the gas exhausting tube 4 to the upstream end of the introduction port 5. Closing of the gas supplying tube 3 is released on the upstream end of the introduction port 5 after the leakage check of the section C to restore the section C to the atmospheric pressure. The section C may be supplied with an inert gas from the gas supplying tube 3 at that time.

Now, described will be the leakage check in setting up the device.

In the leakage check in setting up the device, a detected evacuation pressure is the evacuation pressure under the condition of leakage in the case that the leakage is found in any point of the whole gas flowing path formed from the gas supplying tube 3, the reaction tube 2, the exhausting line 30 and such. Accordingly, the detected evacuation pressure cannot be used as the standard value in the leakage check even when the evacuation pressure is detected. Therefore, existence of leakage is not judged on the basis of whether the detected value (the detected pressure) reaches the standard value (the standard pressure) or not, differently from the leakage check before starting the substrate treatment or in the case of finding any problem. The setting value (the set pressure) is compared with the detected value (the detected pressure) to judge the existence of the leakage on the basis of whether the detected value reaches the setting value or not. Concrete description is as follows.

The setting value of the pressure in the furnace is first set at a value sufficiently lower than that of the atmospheric pressure, 800 hPa, for example, to close the gas exhausting tube 4 on the upstream side of the gas cooler 31 and vacuum-exhaust the exhausting line 30 by means of the vacuum generator 24a used as an exhaust device, as shown in FIG. 4 (STEP: 01). Providing an air valve on the upstream side of the gas cooler 31 to close the air valve, for example, causes the gas exhausting tube 4 to be closed. The pressure in the exhausting line 30 at that time is detected by means of the absolute pressure detecting sensor 24b to be compared with the preset setting value. It is judged that the section reaching the upstream side of the gas cooler (the section A) has no leakage point in the case that a value of the pressure detected in STEP: 01 is same as the setting value. On the other hand, the section A is judged to have a leakage point in the case that the detected pressure value obtained in STEP: 01 is higher than the setting value. Closing of the gas exhausting tube 4 is released on the upstream side of the gas cooler 31 after the leakage check of the section A to restore the section A to the atmospheric pressure. The section A may be supplied with an inert gas from the gas supplying tube 3 at that time.

Next, the upstream end (the exhausting port 9, for example) of the gas exhausting tube 4 is closed as shown in FIG. 5 to vacuum-exhaust the exhausting line 30 by means of the vacuum generator 24a used as an exhaust device under a condition that the setting value of the pressure is set similarly to the case of STEP: 01 (STEP: 02). Providing an air valve in the vicinity of the upstream end of the gas exhausting tube 4 to close the air valve, for example, causes the gas exhausting tube 4 to be closed. The pressure in the exhausting line 30 at that time is detected by means of the absolute pressure detecting sensor 24b to be compared with the preset setting value. It is judged that a section reaching the upstream end of the gas exhausting tube 4 (the section B) has no leakage point in the case that a value of the pressure detected in STEP: 02 is same as the setting value. On the other hand, the section B is judged to have a leakage point in the case that the detected pressure value obtained in STEP: 02 is higher than the setting value.

In the case that the section A has no leakage point while the section B has a leakage point, for example, it is judged that the leakage point exists in a section where the sections A and B are not overlapped with each other, that is, a section from the upstream side of the gas cooler 31 to the upstream end of the gas exhausting tube 4. Closing of the gas exhausting tube 4 is released on the upstream end of the gas exhausting tube 4 after the leakage check of the section B to restore the section B to the atmospheric pressure. The section B may be supplied with an inert gas from the gas supplying tube 3 at that time.

Further, the upstream end of the introduction port 5 is closed as shown in FIG. 6 to vacuum-exhaust the exhausting line 30 and the reaction tube 2 by means of the vacuum generator 24a used as an exhaust device under a condition that the setting value of the pressure is set similarly to the case of STEP: 01 (STEP: 03). Providing an air valve in the vicinity of the upstream end of the introduction port 5 to close the air valve, for example, causes the introduction port 5 to be closed. The pressure in the exhaust line 30 at that time is detected by means of the absolute pressure detecting sensor 24b to be compared with the preset setting value. It is judged that the section reaching the upstream end of the introduction port 5 (the section C) has no leakage point in the case that a value of the pressure detected in STEP: 03 is same as the setting value. On the other hand, the section C is judged to have a leakage point in the case that the detected pressure value obtained in STEP: 03 is higher than the setting value.

In the case that the section B has no leakage point while the section C has a leakage point, for example, it is judged that the leakage point exists in a section where the sections B and C are not overlapped with each other, that is, a section from the upstream end of the gas exhausting tube 4 to the upstream end of the introduction port 5. Closing of the gas supplying tube 3 is released on the upstream end of the introduction port 5 after the leakage check of the section C to restore the section C to the atmospheric pressure. The section B may be supplied with an inert gas from the gas supplying tube 3 at that time.

As the means for closing each portion, used may be an opening and closing valve provided in the exhausting line 30 and the like. Otherwise, a part to be closed may be separated to be closed by means of a hand or an isolation valve may be used.

The substrate treatment is started after it is judged that no leakage point is found in all the sections in the leakage check in setting up the device or in the leakage check before starting the substrate treatment or in the case of any problem found in the device, the leakage checks being described above. In the case of judgment that a leakage point is found in any section in the leakage check in setting up the device or in the leakage check before starting the substrate treatment or in the case of any problem found in the device, a connection part between the members forming the gas flowing path (the gas supplying tube 3, the reaction tube 2, the gas exhausting tube 4, the gas cooler 31, the block 52 and such) in the section is checked to confirm whether the condition of the connection is proper or not. The condition of the connection is improved when the condition is not proper.

Concretely, for a place where the connecting part is fastened by means of fastening fittings or the like, for example, a state of fastening by means of the fastening fittings is checked to fasten the connecting part again or to exchange a member forming the connecting part such as a gas pipe or the fastening fittings. Further, for a place where the connecting part is screwed, for example, a state of screwing is checked to screw the connecting part again or to exchange the connecting part. A member forming the connecting part is affected by heat to be improper state in some cases even when the original state is proper. The screwed part and the fastening fittings, which are described above, may be affected by heat to be loosened in some cases, for example. Influences by heat are accumulated to cause the looseness in accordance with an increase in number of treatment in some cases.

The section for which the leakage check is carried out is not limited to the above. The gas flowing path may be properly closed from the downstream side.

Further, the leakage check is preferably carried out in the order of capacity from a section smallest in capacity among the sections A, B and C, like the above-mentioned order. This allows a leakage point to be specified quickly more than the case of carrying out the leakage check in the order of capacity from a section largest incapacity. That is to say, the leakage point can be efficiently specified.

Moreover, at least the exhausting line 30 in the gas flowing path may be divided into plural sections to perform the leakage check of the exhausting line 30 for each section instead of the leakage check for the sections A, B and C. This allows the exhausting line 30 to be checked for leakage for every section, so that a leakage point can be quickly and easily specified even in the case that leakage exists in the exhausting line 30.

Furthermore, it is also possible to divide the gas flowing path into a first section, which is downstream of the upstream end of the exhausting line 30, and a second section, which is downstream of the upstream end of the introduction port 5 for introducing the gas into the reaction tube 2, to carry out the leakage check. This allows the exhausting line 30 and the reaction tube 2 to be separately checked for leakage. Accordingly, a leakage point can be quickly and easily specified even in the case of existence of leakage.

In addition, the first section of the first section downstream of the upstream end of the exhausting line 30 and the second section downstream of the upstream end of the introduction port 5 for introducing the gas into the reaction tube 2 may be divided into plural sections to perform the leakage check. This allows the exhausting line 30 to be checked for leakage for each of the plural sections. Accordingly, a leakage point can be quickly and easily specified even in the case that leakage exists in the exhausting line 30.

Further, in the case of dividing the gas flowing path into the first section downstream of the upstream end of the exhausting line 30 and the second section downstream of the upstream end of the introduction port 5 for introducing the gas into the reaction tube 2 to carry out the leakage check, preferable is to perform the leakage check in order from the first section to the second section. This allows a leakage point to be specified quickly more than the case of carrying out the leakage check in order from the second section to the first section. That is to say, the leakage point can be efficiently specified.

Moreover, the gas flowing path may be divided into at least the first section, which is downstream of the upstream end of the exhausting line 30, the second section, which is downstream of the upstream end of the introduction port for introducing the gas into the reaction tube 2, and a third section, which is downstream of a predetermined place on the upstream side of the gas supplying tube 3, to carry out the leakage check. This allows the exhaust line 30, the reaction tube 2 and the gas supplying tube 3 to be separately checked for leakage. Accordingly, a leakage point can be quickly and easily specified in the case of existence of leakage.

Additionally, in the case of dividing the gas flowing path into the first section, which is downstream of the upstream end of the exhausting line 30, the second section, which is downstream of the upstream end of the introduction port for introducing the gas into the reaction tube 2, and the third section, which is downstream of a predetermined place on the upstream side of the gas supplying tube 3, to perform the leakage check, preferable is to perform the leakage check in the order of the first section, the second section and the third section. This allows a leakage point to be specified quickly more than the case of carrying out the leakage check in the order of the third section, the second section and the first section. That is to say, the leakage point can be efficiently specified.

In addition to the above, the invention is specifically effectively applied to the oxidization and diffusion treatment process using the oxidization and diffusion device among the processes of manufacturing a semiconductor device (device). That is to say, the oxidization and diffusion device can be considered to be complicated in structure of the exhausting line more than the other devices such as a CVD device. The exhausting line of the oxidization and diffusion device is provided with a member, which is not provided in the CVD device, such as a gas cooler and a fluid discharging line, for example. This causes a connecting point between the members forming the exhausting line to be comparatively increased in number. Further, the oxidization and diffusion device is higher in temperature in the furnace than the CVD device. Accordingly, the pressure control valve should be provided away from the reaction furnace so as not to be affected by the heat. This requires that the length from the exhaust port to the pressure control valve should be longer than the case of the CVD device. Moreover, the exhausting line of the oxidization and diffusion device includes many parts made of fluorocarbon resin and many screwed connecting parts. The part made of fluorocarbon resin is friable at a joint portion. As described above, in the oxidization and diffusion device, the exhausting line is comparatively complicated in structure, the connecting point between the members forming the exhausting line is comparatively large in number, the length from the exhaust port to the pressure control valve is comparatively long and the part made of fluorocarbon resin and screwed connecting part are comparatively large in number. In accordance with the above, it can be considered that there are comparatively many places, which may be leakage points. Therefore, the invention is particularly effective in the case of application to the oxidization and diffusion device having comparatively large number of places, which may be leakage points, as described above.

(Supplementary Note)

Further, the invention includes the following modes for carrying out the invention.

(Supplementary Note 1)

A method of manufacturing a semiconductor device comprising the steps of: carrying a substrate into a reaction tube; processing the substrate by supplying a gas into the reaction tube from a gas supply line, while exhausting an inside of the reaction tube through an exhaust line by means of an exhaust device and controlling pressure in the reaction tube on the basis of an output from a pressure sensor provided in the exhaust line; carrying the processed substrate out from the reaction tube; and carrying out a leakage check for a gas flowing path including the gas supply line, the reaction tube and the exhaust line, wherein, in the step of carrying out the leakage check, the gas flowing path is divided into plural sections connecting with at least the pressure sensor and the exhaust device, the respective sections are exhausted by means of the exhaust device with an upstream end of each section being closed and pressure in each section is measured by means of the pressure sensor to judge for every section whether leakage is found in the gas flowing path or not on the basis of the measured pressure. In accordance with the mode, the gas flowing path can be checked for leakage for every section, so that a leakage point can be quickly and easily specified in the case of existence of leakage. Moreover, using the pressure sensor provided in the exhausting line allows the exhausting line to be individually checked for leakage.

(Supplementary Note 2)

The method of manufacturing a semiconductor device according to Note 1, wherein, in the step of carrying out the leakage check, existence of leakage is judged in order from a most downstream section of the gas flowing path to an upstream side. In accordance with the mode, in addition to the effect of Supplementary Note 1, the a leakage point can be specified quickly and easily in the case of existence of leakage more than the case of the leakage check in order from the most upstream section to the downstream side. That is to say, the leakage point can be efficiently specified.

(Supplementary Note 3)

The method of manufacturing a semiconductor device according to Note 1, wherein, in the step of carrying out the leakage check, existence of leakage is judged in order of small size capacity from a section of the gas flowing path, the section smallest in capacity. In accordance with the mode, in addition to the effect of Supplementary Note 1, a leakage point can be specified quickly in the case of existence of leakage more than the case of the leakage check in the order of capacity from a section largest in capacity. That is to say, the leakage point can be efficiently specified.

(Supplementary Note 4)

The method of manufacturing a semiconductor device according to Note 1, wherein, in the step of carrying out the leakage check, at least the exhaust line in the gas flowing path is divided into the plural sections to judge whether the leakage exists in the exhaust line or not for every section. In accordance with the mode, in addition to the effect of Supplementary Note 1, the exhausting line can be checked for leakage for every section, so that a leakage point can be quickly and easily specified even in the case that leakage exists in the exhausting line.

(Supplementary Note 5)

The method of manufacturing a semiconductor device according to Note 1, wherein, in the step of carrying out the leakage check, the gas flowing path is divided into at least a first section on downstream side of an upstream end of the exhaust line and a second section on downstream side of an upstream end of an introduction port for introducing the gas into the reaction tube to judge whether the leakage exists or not for every section. In accordance with the mode, in addition to the effect of Supplementary Note 1, the exhausting line and the reaction tube can be separately checked for leakage. This allows a leakage point to be quickly and easily specified in the case of existence of leakage.

(Supplementary Note 6)

The method of manufacturing a semiconductor device according to Note 5, wherein, in the step of carrying out the leakage check, the first section is further divided into plural sections to judge whether the leakage exists or not for every section. In accordance with the mode, in addition to the effect of Supplementary Note 5, the exhausting line can be checked for leakage for every section, so that a leakage point can be quickly and easily specified even in the case of existence of leakage.

(Supplementary Note 7)

The method of manufacturing a semiconductor device according to Note 5, wherein, in the step of carrying out the leakage check, existence of the leakage is judged in order of the first section and the second section. In accordance with the mode, in addition to the effect of Supplementary Note 5, the a leakage point can be specified quickly in the case of existence of leakage more than the case of the leakage check in order from the second section to the first section. That is to say, the leakage point can be efficiently specified.

(Supplementary Note 8)

The method of manufacturing a semiconductor device according to Note 1, wherein, in the step of carrying out the leakage check, the gas flowing path is divided into at least a first section on downstream side of an upstream end of the exhaust line, a second section on downstream side of an upstream end of an introduction port for introducing the gas into the reaction tube, and a third section on downstream side of a predetermined place on an upstream side of the gas supply line to judge whether the leakage exists or not for every section. In accordance with the mode, in addition to the effect of Supplementary Note 1, the exhaust line, the reaction tube and the gas supplying line can be separately checked for leakage. Accordingly, a leakage point can be quickly and easily specified in the case of existence of leakage.

(Supplementary Note 9)

The method of manufacturing a semiconductor device according to Note 8, wherein, in the step of carrying out the leakage check, existence of the leakage is judged in order of the first section, the second section and the third section. In accordance with the mode, in addition to the effect of Supplementary Note 8, a leakage point is specified quickly in the case of existence of leakage more than the case of carrying out the leakage check in the order of the third section, the second section and the first section. That is to say, the leakage point can be efficiently specified.

(Supplementary Note 10)

The method of manufacturing a semiconductor device according to Note 1, further comprising: closing an upstream side of the gas supply line with no leakage existing in the gas flowing path and vacuum-exhausting the inside of the reaction tube by means of the exhaust device to measure attained pressure at the time; and storing the measured attained pressure as a standard pressure, wherein, in the step of carrying out the leakage check, the measured pressure in each section is compared with the stored standard pressure to judge whether the leakage exists or not in the gas flowing path for every section. In accordance with the mode, in addition to the effect of Supplementary Note 1, it can be easily judged whether the leakage exists or not.

(Supplementary Note 11)

The method of manufacturing a semiconductor device according to Note 10, wherein, in the step of carrying out the leakage check, it is judged that no leakage point exists in a certain section among the respective sections when the measured pressure in the section is equal to the standard pressure while it is judged that a leakage point exists in a certain section when the measured pressure of the section is not equal to the standard pressure. In accordance with the mode, in addition to the effect of Supplementary Note 10, it can be further easily judged whether the leakage exists or not.

(Supplementary Note 12)

A method of manufacturing a semiconductor device comprising the steps of: carrying a substrate into a reaction tube; processing the substrate by supplying a gas into the reaction tube from a gas supply line, while exhausting an inside of the reaction tube through an exhaust line by means of an exhaust device and controlling pressure in the reaction tube on the basis of an output from a pressure sensor provided in the exhaust line; carrying the processed substrate out from the reaction tube; and carrying out a leakage check for at least the exhaust line in a gas flowing path including the gas supply line, the reaction tube and the exhaust line, wherein, in the step of carrying out the leakage check, the exhaust line is divided into plural sections connecting with at least the pressure sensor and the exhaust device, the respective sections are exhausted by means of the exhaust device with an upstream end of each section being closed and pressure in each section is measured by means of the pressure sensor to judge for every section whether leakage is found in the exhaust line or not on the basis of the measured pressure. In accordance with the mode, the exhausting line can be checked for leakage for every section, so that a leakage point can be quickly and easily specified even in the case that the leakage exists in the exhausting line.

(Supplementary Note 13)

13. The method of manufacturing a semiconductor device according to Note 12, wherein, in the step of processing the substrate, exhaust is carried out through the exhaust line connected to a gas cooler and a fluid discharging line by means of the exhaust device. In accordance with the mode, in addition to the effect of Supplementary Note 12, a leakage point can be quickly and easily specified although many connecting points between the members forming the exhausting line cause a place, which may be a leakage point, to comparatively increase in number in the exhausting line in the case that the exhausting line is connected to the gas cooler or the fluid discharging line.

(Supplementary Note 14)

The method of manufacturing a semiconductor device according to Note 12, wherein, in the step of processing the substrate, exhaust is carried out through the exhaust line including a piping made of fluorocarbon resin by means of the exhaust device. In accordance with the mode, in addition to the effect of Supplementary Note 12, a leakage point can be quickly and easily specified although the place, which may be a leakage point, comparatively increases in number in the exhausting line in the case that the exhausting line includes a pipe made of fluorocarbon resin.

(Supplementary Note 15)

The method of manufacturing a semiconductor device according to Note 12, wherein, in the step of processing the substrate, oxidization process or diffusion process is performed for the substrate. In accordance with the mode, in addition to the effect of Supplementary Note 12, a leakage point can be quickly and easily specified even in the case of performing the oxidization treatment or the diffusion treatment, which uses a device complicated in structure and comparatively easily leaked.

1. A method of manufacturing a semiconductor device comprising the steps of:
carrying a substrate into a reaction tube;
processing the substrate by supplying a gas into the reaction tube from a gas supply line, while exhausting an inside of the reaction tube through an exhaust line by means of an exhaust device and controlling pressure in the reaction tube on the basis of an output from a pressure sensor provided in the exhaust line;
carrying the processed substrate out from the reaction tube; and
carrying out a leakage check for a gas flowing path including the gas supply line, the reaction tube and the exhaust line,
wherein, in the step of carrying out the leakage check, the gas flowing path is divided into plural sections connecting with at least the pressure sensor and the exhaust device, the respective sections are exhausted by means of the exhaust device with an upstream end of each section being closed and pressure in each section is measured by means of the pressure sensor to judge for every section whether leakage is found in the gas flowing path or not on the basis of the measured pressure.

2. The method of manufacturing a semiconductor device according to claim 1, wherein,
in the step of carrying out the leakage check, existence of leakage is judged in order from a most downstream section of the gas flowing path to an upstream side.

3. The method of manufacturing a semiconductor device according to claim 1, wherein,
in the step of carrying out the leakage check, existence of leakage is judged in order of small size capacity from a section of the gas flowing path, the section smallest in capacity.

4. The method of manufacturing a semiconductor device according to claim 1, wherein,
in the step of carrying out the leakage check, at least the exhaust line in the gas flowing path is divided into the plural sections to judge whether the leakage exists in the exhaust line or not for every section.

5. The method of manufacturing a semiconductor device according to claim 1, wherein,
in the step of carrying out the leakage check, the gas flowing path is divided into at least a first section on downstream side of an upstream end of the exhaust line and a second section on downstream side of an upstream end of an introduction port for introducing the gas into the reaction tube to judge whether the leakage exists or not for every section.

6. The method of manufacturing a semiconductor device according to claim 5, wherein,
in the step of carrying out the leakage check, the first section is further divided into plural sections to judge whether the leakage exists or not for every section.

7. The method of manufacturing a semiconductor device according to claim 5, wherein,
in the step of carrying out the leakage check, existence of the leakage is judged in order of the first section and the second section.

8. The method of manufacturing a semiconductor device according to claim 1, wherein,
in the step of carrying out the leakage check, the gas flowing path is divided into at least a first section on downstream side of an upstream end of the exhaust line, a second section on downstream side of an upstream end of an introduction port for introducing the gas into the reaction tube, and a third section on downstream side of a predetermined place on an upstream side of the gas supply line to judge whether the leakage exists or not for every section.

9. The method of manufacturing a semiconductor device according to claim 8, wherein,
in the step of carrying out the leakage check, existence of the leakage is judged in order of the first section, the second section and the third section.

10. The method of manufacturing a semiconductor device according to claim 1, further comprising:
closing an upstream side of the gas supply line with no leakage existing in the gas flowing path and vacuum-exhausting the inside of the reaction tube by means of the exhaust device to measure attained pressure at the time; and
storing the measured attained pressure as a standard pressure,
wherein, in the step of carrying out the leakage check, the measured pressure in each section is compared with the stored standard pressure to judge whether the leakage exists or not in the gas flowing path for every section.

11. The method of manufacturing a semiconductor device according to claim 10, wherein,
in the step of carrying out the leakage check, it is judged that no leakage point exists in a certain section among the respective sections when the measured pressure in the section is equal to the standard pressure while it is judged that a leakage point exists in a certain section when the measured pressure of the section is not equal to the standard pressure.

12. A method of manufacturing a semiconductor device comprising the steps of:
carrying a substrate into a reaction tube;
processing the substrate by supplying a gas into the reaction tube from a gas supply line, while exhausting an inside of the reaction tube through an exhaust line by means of an exhaust device and controlling pressure in the reaction tube on the basis of an output from a pressure sensor provided in the exhaust line;
carrying the processed substrate out from the reaction tube; and
carrying out a leakage check for at least the exhaust line in a gas flowing path including the gas supply line, the reaction tube and the exhaust line,
wherein, in the step of carrying out the leakage check, the exhaust line is divided into plural sections connecting with at least the pressure sensor and the exhaust device, the respective sections are exhausted by means of the exhaust device with an upstream end of each section being closed and pressure in each section is measured by means of the pressure sensor to judge for every section whether leakage is found in the exhaust line or not on the basis of the measured pressure.

13. The method of manufacturing a semiconductor device according to claim 12, wherein,
in the step of processing the substrate, exhaust is carried out through the exhaust line connected to a gas cooler and a fluid discharging line by means of the exhaust device.

14. The method of manufacturing a semiconductor device according to claim 12, wherein,
in the step of processing the substrate, exhaust is carried out through the exhaust line including a piping made of fluorocarbon resin by means of the exhaust device.

15. The method of manufacturing a semiconductor device according to claim 12, wherein,
in the step of processing the substrate, oxidization process or diffusion process is performed for the substrate.
